(19) United States
(12) Patent Application Publication
(10) Pub. No.: US 2004/0217113 A1
(43) Pub. Date: Nov. 4, 2004

(54) A Disposable Cover for dishes and bowls during the heating or cooking of foods in the microwave oven.

(76) Inventor: Tom Dancu, Mt Prospect, IL (US)

Correspondence Address: TOM DANCU, 1749 GOLF RD #133, MT PROSPECT, IL, 60056, US

(21) Appl. No.: 10/249,654

(22) Filed: Apr. 29, 2003

(51) Int. Cl. H05B 6/80

(52) U.S. Cl. 219/735

(57) ABSTRACT

This invention covers a disposable cover for use in a microwave oven to eliminate spatter and optimize the application of heat to food. A monocque shape lends itself to one-piece construction at the same time allowing for a variety of shapes. Laminated paper provides benefits in accomplishing the heating objective as well as rigidity and moisture protection

### BACKGROUND OF INVENTION

This invention relates to a cover that is disposable and economical to manufacture. Microwave ovens have become commonplace in today's kitchens. In our culture the convenience is most attractive. One downside is that often, in haste to prepare food, uncovered food often leads to food spattering onto the interior walls. The disposable cover of this invention addresses the spatter problem, at the same time providing the benefit of concentrating the microwave's heat onto the subject food.

The invention incorporates features and benefits that prior art fails to consider. Monocque construction provides a simpler means of protecting the oven from spatter by allowing for one-piece construction, an economic necessity for a disposable item. Features such as a vent and handles to provide safety from the release of accumulated heat can be provided as an integral part. The cover is designed to sit on the edge of microwave dishes and bowls. This feature combined with laminate paper results in elevating the temperature underneath the cover. The benefit is a reduction in reheat time and more efficient use of the microwave's energy. The laminated paper is non-gas permeable and moisture resistance. The monocque shape was developed for low cost production.

Disposable products are increasingly becoming more popular with consumers. My invention will satisfy the consumers penchant for disposable products, and satisfy the commercial need for low manufacturing costs.

The prior art discloses many examples of covers for the use in the microwave. The following are the results of my research:

U.S. Pat. Nos. 297,298 2,867,026 3,448,888 4,345,133 4,425,368 4,532,397 4,795,056 4,801,773 5,012,061 5,302,791 6,325,234

### SUMMARY OF INVENTION

The primary objective of the invention is to provide an improved disposable cover and to make such objects more commercially viable. The invention utilizes a monocque shape to make the cover self-supporting. This approach allows the shape to be constructed from a flat piece of laminated paper wherein all relevant features can be laid out prior to forming and gluing. The uniquely designed disposable cover will rest on the edges of dishes and bowls, or slightly overlap smaller ones, thereby creating a seal with the dish. As food is heating up, the temperate underneath the cover becomes elevated thus reducing the reheating time. The laminate paper is non-gas permeable and gas can only escape through the vent at the top. Laminated paper keeps the moisture under the cover and will tend to prevent the food from drying out prematurely. And, of course, the cover will trap any spatter keeping the oven clean, which is one of the primary objectives.

Monocque shapes were selected because they derive their strength from their shape. It is possible to use very thin materials and still provide the rigidity necessary to have a non-collapsible cover under a variety of circumstances. The shape in the invention is designed to fit the most popular sizes of dishes and bowls. One of the monocque shapes, a cone, provides a chimney to vent the build up of gases and steam inside the disposable cover. The monocque shape means the cover has no horizontal surface to collapse regardless of the amount of moisture given off by the food or liquid. Monocque shapes are inherently easier to manufacture, for example the conical water cups and snow cone cups.

The handle is provided at the top allowing the cook to safely remove the cover without the danger of getting a steam burn. The handle is located near the center of gravity of the disposable cover making it easier to handle.

The rigidity of the monocque shape plus the properties of the laminated material make it possible that the consumer could get multiple uses out of any one cover; thereby reducing his cost.

### BRIEF DESCRIPTION OF DRAWINGS

FIG. 1 is a perspective view of the invention.

FIG. 2 is top view of the invention.

FIG. 3 is an elevation view of the invention.

FIG. 4 is a perspective view of another possible shape.

FIG. 5 is top view of another possible shape.

FIG. 6 is an elevation view of another possible.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

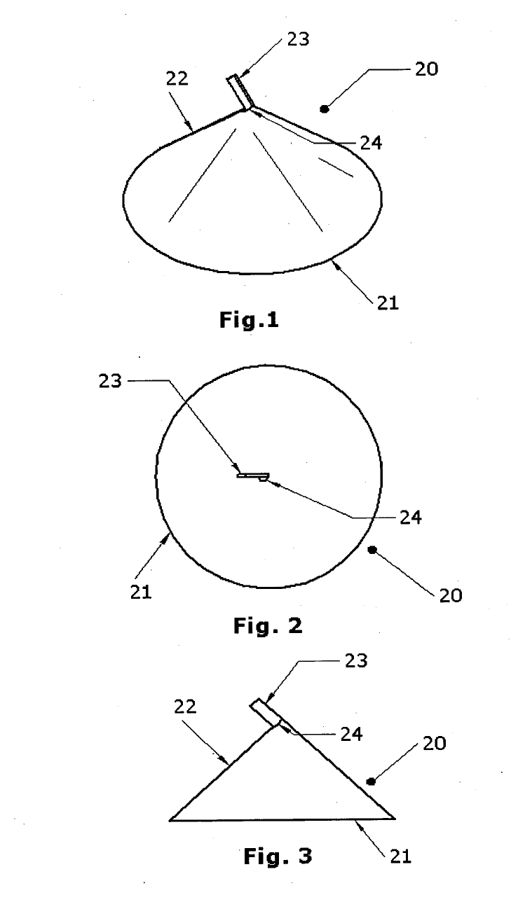

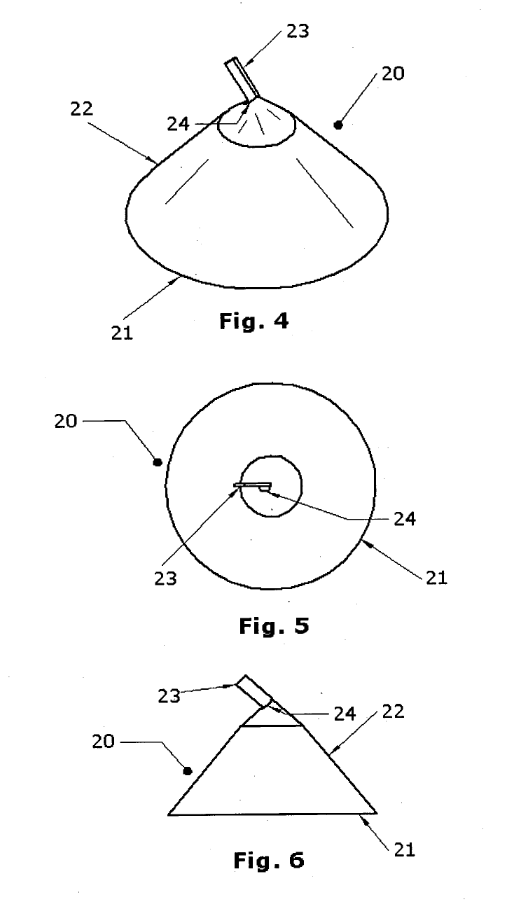

FIG. 1-6 best illustrates the disposable cover, 20. Monocque shape is shown as it would be placed over the dish or bowl in the microwave. The rim, 21 or circumference of the cone is larger than the most popular dish size. The dish or bowl will rest on the inside of the wall, 22. The wall, 22, made of the laminate paper provides a rigid barrier. The wall, 22, is angled toward the center. This creates a chimney affect to direct the gases and moisture toward the vent, 24 located near the apex. The vent, 24, is a hole near the apex. The handle, 23, is located in the apex and is an integral part of the wall, 22. The handle, 23 makes for easily of removal form the dish or bowl.

Although the invention has been shown and described with respect to exemplary embodiments thereof, various other changes, omissions, and additions in form and detail thereof may be made therein without departing from the spirit and scope of the invention.

1. A disposable cover, which eliminates spatter and optimizes the application of heat to food prepared in a microwave oven and comprising: (a) A self-supporting, monocque shape, and (b) One-piece construction, having (c) A circular base and a singular upward vertex, and (d) A non-permeable, moisture resistant, laminated material.

2. A disposable cover described in claim 1 where the base radius is proportional to the height such as to fit popular sizes of dishes and bowls.

3. A disposable cover described in claim 1 where the monocque shape has the unique height necessary to prevent contact with the food.

4. An improvement of claim 1 wherein at least one handle is incorporated within the one-piece construction at the top of the monocque shape.

5. An improvement of claim 1 wherein one vent is integrally formed at the point of the monocque shape allowing gas and vapor to escape during heating.
